(19) United States
(12) Patent Application Publication
(10) Pub. No.: US 2026/0285514 A1
(43) Pub. Date: Sep. 24, 2026

(54) Hydrogen Powered Vertical Take-Off And Landing Aircraft

(71) Applicant: Joby Aero, Inc., Santa Cruz, CA (US)

(72) Inventors: Gregor Veble Mikic, Santa Cruz, CA (US); JoeBen Bevirt, Santa Cruz, CA (US); Edward Stilson, Santa Cruz, CA (US); Zach Reeder, Santa Cruz, CA (US); David Benjamin Troner, Santa Cruz, CA (US); Alec Morgan Clarke, Austin, TX (US); Alborz Sakhaei, Irvine, CA (US)

(21) Appl. No.: 19/554,629

(22) Filed: Mar. 2, 2026

Related U.S. Application Data
(60) Provisional application No. 63/766,382, filed on Mar. 4, 2025.

(51) Int. Cl. B64U 50/32; B64C 27/32; B64C 29/00; B64D 27/34; B64D 27/355; B64D 37/04; B64D 37/30; B64U 10/20; B64U 20/00; B64U 30/295; B64U 30/297; B64U 50/19; H01M 8/04082

(52) U.S. Cl. CPC B64U 50/32; B64C 27/32; B64C 29/0033; B64D 27/34; B64D 27/355; B64D 37/04; B64D 37/30; B64U 10/20; B64U 20/00; B64U 30/295; B64U 30/297; B64U 50/19; H01M 8/04201; H01M 2250/20

(57) ABSTRACT

An aerial vehicle configured with a main fuselage and a rotating wing set coupled to the top of the main fuselage. In some aspects, the aerial vehicle is a vertical take-off and landing aircraft. The aircraft main body may have a hydrogen fuel cell system and batteries within the aircraft. The aircraft may have electric motor driven rotor assemblies which provide thrust for both vertical take-off and landing and forward flight operations. The electric motor driven rotor assemblies may be powered by electric power from a combination of the fuel cell system and battery system. In some aspects, the hydrogen fuel source may be directly combusted in a gas turbogenerator to provide electric power. The aircraft may have pivoting wings with rotor assemblies which may provide thrust in both a forward flight configuration and a vertical take-off and landing (hover) configuration.

### CROSS-REFERENCE TO RELATED APPLICATIONS

This application is claims priority to U.S. Provisional Patent Application No. 63/766,382 to Mikic et al., filed Mar. 4, 2025, which is hereby incorporated by reference in its entirety.

### FIELD OF THE INVENTION

This invention relates to aerial vehicles, including a vertical take-off and landing aircraft with pivoting wings.

### SUMMARY OF THE INVENTION

An aerial vehicle configured with a main fuselage and a rotating wing set coupled to the top of the main fuselage. In some aspects, the aerial vehicle is a vertical take-off and landing aircraft. The aircraft main body may have a hydrogen fuel cell system and batteries within the aircraft. The aircraft may have electric motor driven rotor assemblies which provide thrust for both vertical take-off and landing and forward flight operations. The electric motor driven rotor assemblies may be powered by electric power from a combination of the fuel cell system and battery system. In some aspects, the hydrogen fuel source may be directly combusted in a gas turbogenerator to provide electric power. The aircraft may have pivoting wings with rotor assemblies which may provide thrust in both a forward flight configuration and a vertical take-off and landing (hover) configuration.

### BRIEF DESCRIPTION OF THE DRAWINGS

FIG. 1 is an illustration of a VTOL aircraft in a forward flight configuration according to some embodiments of the present invention.

FIG. 2 is an illustration of a VTOL aircraft in a hover configuration according to some embodiments of the present invention.

FIG. 3 is a top view of a VTOL aircraft in a hover configuration according to some embodiments of the present invention.

FIG. 4 is a front view of a VTOL aircraft in a hover configuration according to some embodiments of the present invention.

FIG. 6 is a front perspective view of a VTOL aircraft in a forward flight configuration according to some embodiments of the present invention.

FIG. 7 is a front perspective view of a VTOL aircraft in a hover configuration according to some embodiments of the present invention.

FIG. 8 is a side view of a VTOL aircraft in a hover configuration according to some embodiments of the present invention.

FIGS. 9A-C are illustrations of wing cant according to some embodiments of the present invention.

### DETAILED DESCRIPTION

Aerial vehicles according to embodiments of the present invention function to provide an aerial vehicle operable between a hover mode and a forward mode. The hover mode can include vertical takeoff, vertical landing, and/or substantially stationary hovering of the aircraft; however, the hover mode can additionally or alternatively include any suitable operating mode wherein vertically-directed thrust is generated by one or more of the plurality of propulsion assemblies. The forward mode can include forward flight, horizontal takeoff, and/or horizontal landing of the aircraft (e.g., conventional take-off and landing/CTOL); however, the forward mode can additionally or alternatively include any suitable operating mode wherein horizontally-directed thrust is generated by one or more of the plurality of propulsion assemblies. The aircraft can also function to provide an aerial vehicle that is stable in hover mode (e.g., maximally stable, stable within a defined stability window or envelope of flight conditions, stable up to a stability threshold magnitude of various control inputs to the aircraft, etc.) and efficient (e.g., aerodynamically efficient, power efficient, thermodynamically efficient, etc.) in forward mode. The aircraft can also function to provide airborne transportation to passengers and/or cargo. However, the aircraft can additionally or alternatively have any other suitable function.

The propeller of the propulsion assembly functions to convert rotational kinetic energy supplied by the electric motor to aerodynamic forces (e.g., for propelling the aircraft in the hover mode, the forward mode, etc.). The propeller can include a number of propeller blades (e.g., blades, airfoils, etc.), a head (e.g., a hub and associated linkages), and any other suitable components. The propeller may be a variable-pitch propeller (e.g., wherein the pitch of each propeller blade is variable coordination such as via collective control, wherein the pitch of each propeller blade is independently variable such as via cyclic control, etc.), but can additionally or alternatively be a fixed-pitch propeller. In some variations, the aircraft can include both variable-pitch and fixed-pitch propeller associated with different propulsion assemblies of the plurality of propulsion assemblies. In additional or alternative variations, the propeller can be articulated into a negative angle of attack condition, which can function to produce reverse thrust without changing the direction of rotation of the propeller. The propeller can define any suitable disc area (e.g., propeller disc, disc, etc.), and each blade can define any suitable cross section and/or twist angle as a function of blade span.

In a specific example, each propeller of the plurality of propulsion assemblies includes a set of propeller blades attached to the hub by a variable pitch linkage that rotates each propeller blade about a long axis of the propeller blade and constrains propeller blade motion normal to the disc plane (e.g., the propeller blade does not substantially articulate forward or backward from the disc plane). The propellers can provide lift associated with an angle of attack relative to the incoming airstream during forward flight, relative to the longitudinal axis of the aircraft, and/or relative to the wing of the aircraft as defined by the chord line of the wing cross-section, as discussed further below. In an exemplary embodiment, the aerial vehicle may utilize the propeller blades in an increased pitch configuration during hover operations, such as when taking off and landing the aerial vehicle.

Aircraft according to embodiments of the present invention can include a power distribution system that couples an electric power source to each electrically-powered component (e.g., including each electric motor). The power distribution system can include an electrical power transmission bus that distributes power from a plurality of electric power sources to components of the aircraft requiring electrical power. Each propulsion assembly is preferably connected to at least one associated electric power source that powers the electric motor assembly of the propulsion assembly. However, the electric power sources can additionally or alternatively be interconnected to one another and/or to one or more propulsion assemblies such that any propulsion assembly (or other powered component) can draw electrical power from any suitable subset of electric power sources of the aircraft 100, with any suitable relative power draw between electric power sources.

In some embodiments of the present invention, the aerial vehicle is configured to provide a payload area and to allow loading and unloading access to this payload area for cargo. The main body of the aerial vehicle may include space within to accommodate most or all of the power provision components for the aerial vehicle, which may include batteries, fuel cell systems, or other power components, including fuel. The main body may also include space within to accommodate the flight electronics of the aerial vehicle.

In some aspects, inletted air may be routed to a thermodynamic fuel cell system, as discussed further below. The batteries may be used to provide auxiliary power as needed in addition to the power provided by the fuel cell. In some aspects, the batteries are sized to provide full power for takeoff and landing hovers, for transition, and for initial climbing in addition to emergency procedures and failure cases. The fuel cell is adapted to provide charging for the batteries during flight.

In some aspects, inletted air may be routed to a which directly combusts the hydrogen fuel to generate electrical power. The batteries may be used to provide auxiliary power as needed in addition to the power provided by the fuel cell. In some aspects, the batteries are sized to provide full power for takeoff and landing hovers, for transition, and for initial climbing in addition to emergency procedures and failure cases. The gas turbogenerator is adapted to provide charging for the batteries during flight.

In some aspects, the aerial vehicle does not include active control systems or actuators. Instead, fixed aerodynamic surfaces on the fuselage are used to maintain proper attitude during forward flight, and the aerial vehicle is loaded to ensure that the fuselage center of gravity remains longitudinally close to the wing's rotation center.

Trim tabs extending from the nacelles may be included to provide aerodynamic balance to the wing in forward flight.

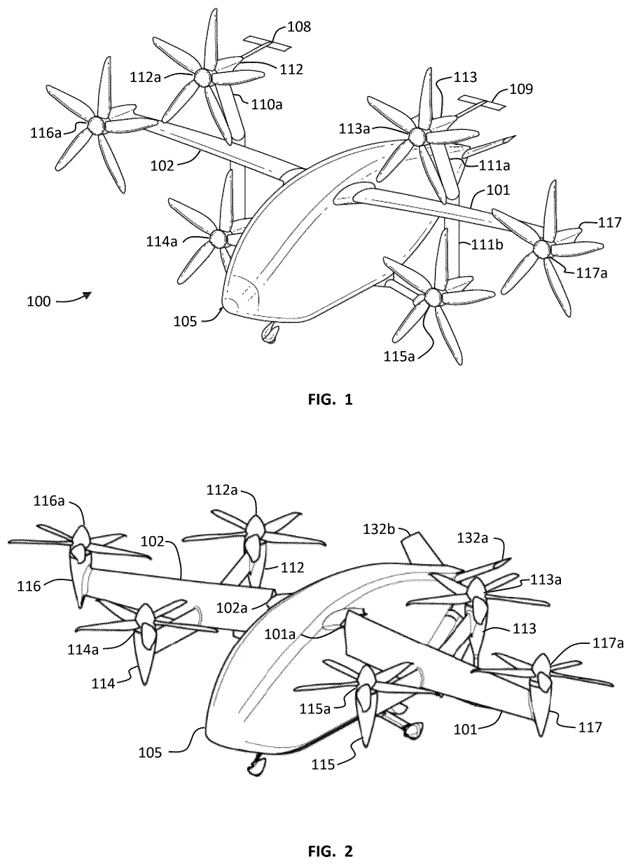

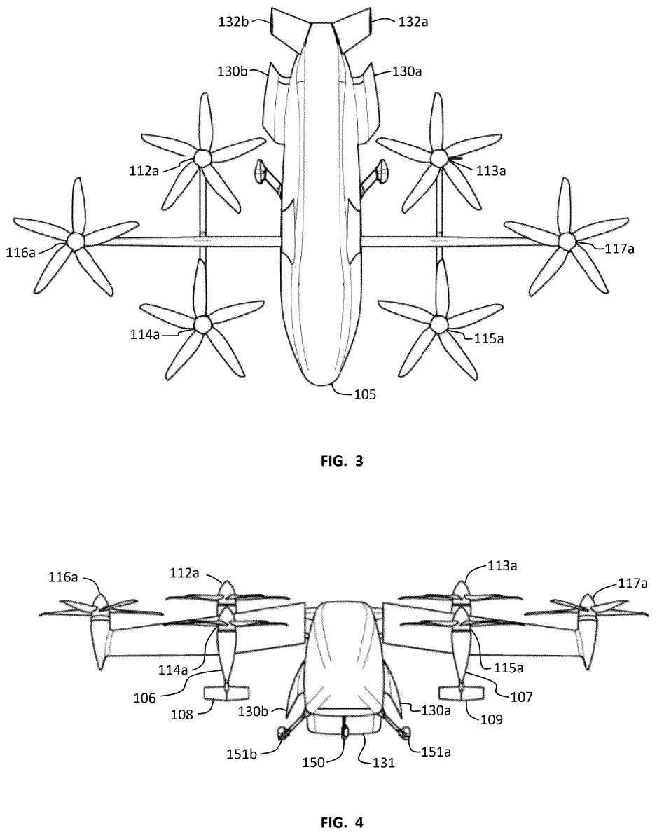

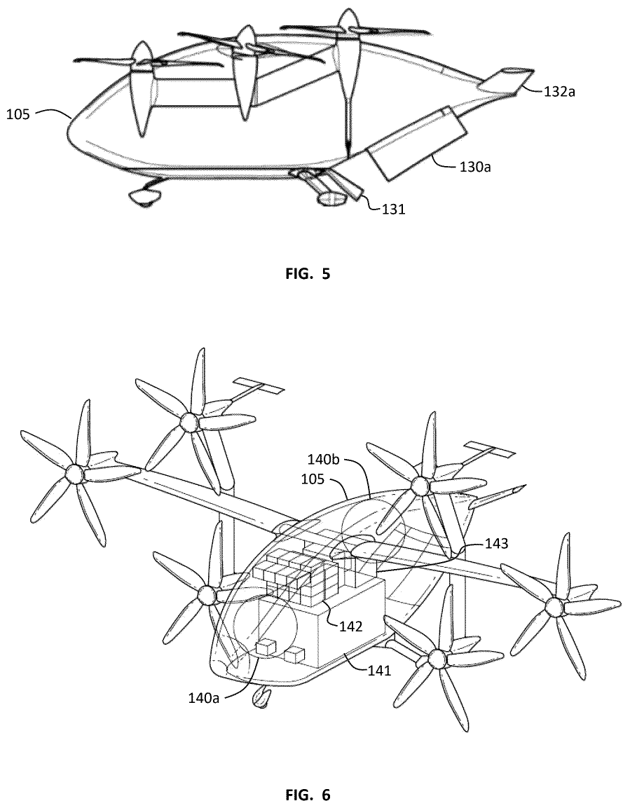

In a first illustrative embodiment of the present invention, as seen in a forward flight configuration in FIGS. 1-4, an aerial vehicle 100 has a main body fuselage 105 coupled to a left wing 101 and a right wing 102. In this illustrative embodiment, the fuselage 105 resides predominantly below the wings 101, 102 so that the center of mass of the fuselage is below the wings. In some aspects, the left wing 101 and the right wing 102 are coupled together to form a unitary wing set. In some aspects, the left wing 101 and the right wing 102 are coupled to the main body fuselage 105 at an upper portion of said main body fuselage. In some aspects, one or more structural elements extend from the left wing 101 and the right wing 102 through the main body 105 to provide continuous, fixed, support coupling the wings together.

In this illustrative six rotor embodiment, the left wing 101 has a pylon 111 with an upper pylon 111a coupled to an upper motor nacelle 113. An upper left wing propulsion assembly 113a is coupled to a forward end of the upper motor nacelle 113. The lower pylon 111b is coupled to a lower motor nacelle 115. A lower left wing propulsion assembly 115a is coupled to a forward end of the lower motor nacelle 115. In some aspects, the left side upper pylon 111a may be canted forward such the rotor disc of the upper left wing propulsion assembly is forward of the lower left wing propulsion assembly. In some aspects, the left side upper pylon 111a may be canted forward such the rotor disc of the upper left wing propulsion assembly is forward of the leading edge of the left wing. The right wing 102 has a pylon 110 with an upper pylon 110a coupled to an upper motor nacelle 112. An upper right wing propulsion assembly 112a is coupled to a forward end of the upper motor nacelle 110. The lower pylon 110b is coupled to a lower motor nacelle 114. A lower right wing propulsion assembly 114a is coupled to a forward end of the lower motor nacelle 114. In some aspects, the right side upper pylon 110a may be canted forward such the rotor disc of the upper ring wing propulsion assembly is forward of the lower right wing propulsion assembly. In some aspects, the right side upper pylon 110a may be canted forward such the rotor disc of the upper right wing propulsion assembly is forward of the leading edge of the right wing

In an illustrative embodiment, each of the propulsion assemblies has an electric motor coupled to a propeller, with a blade pitch control mechanism configured to adjust the blade pitch of each of the propeller blades simultaneously. A left wingtip nacelle 117 with a left wingtip rotor 117a is coupled to the outboard tip of the left wing 101, and a right wingtip nacelle 116 with a right wingtip rotor 116a is coupled to the outboard tip of the right wing 102. At the rearward end of the left side wing nacelle 107 is a landing strut 109, and at the rearward end of the right side wing nacelle 106 is a landing strut 108. In some aspects, the rearward projection from the upper nacelles may provide a fixed aerodynamic surface to assist in aircraft trim in forward flight. The fixed aerodynamic surface may be seen on both sides of the aircraft.

The angle of attack of the upper right wing propulsion assembly 112a and the lower right wing propulsion assembly 114a may be offset from the wing of the aircraft, as defined by the chord of the cross-section of the wing, by a first angle. The angle of attack of the upper left wing propulsion assembly 113 and the lower left wing propulsion assembly 115a may be offset from the wing of the aircraft, as defined by the chord of the cross-section of the wing, by the same first angle. The angle of attack of the right wingtip rotor 116a and the left wingtip rotor 117a may be offset from the wing of the aircraft by a second angle. Using a different offset angle on the wingtip rotors relative to the offset angle of the inboard rotors may allow for better yaw control during hover operations of the aircraft. In some aspects, one of either the wingtip rotors or the inboard rotors may be not be offset, with the other offset at a non-zero angle.

In an illustrative embodiment, the angle of attack of the upper right wing propulsion assembly 112a and the lower right wing propulsion assembly 114a and the upper left wing propulsion assembly 113a and the lower left wing propulsion assembly 115a may be offset from the wing of the aircraft by zero degrees (not offset), as defined by the chord of the cross-section of the wing, while the angle of attack of the right wingtip rotor 116 and the left wingtip rotor 117 may be offset from the wing of the aircraft by +9 degrees. In another illustrative example, the angle of attack of the upper right wing propulsion assembly 112a and the lower right wing propulsion assembly 114a and the upper left wing propulsion assembly 113a and the lower left wing propulsion assembly 115a may be offset from the wing of the aircraft by a first angle in the range of −3 to +3 degrees, as defined by the chord of the cross-section of the wing, while the angle of attack of the right wingtip rotor 116 and the left wingtip rotor 117 may be offset from the wing of the aircraft by a second angle in the range of 6-12 degrees. In some aspects, all of the rotors (inboard and wingtip) may be offset by an angle in the range of −5 to +15 degrees, with the inboard rotors offset from the wingtip rotors as discussed above. In some aspects, all of the rotors (inboard and wingtip) may be offset by an angle in the range of −15 to +30 degrees, with the inboard rotors offset from the wingtip rotors as discussed above. It should be understood that a rotor offset to the wing chord by a negative angle does not necessarily lead to a situation where the rotor is canted downward relative to the freestream, as the wing itself may be flown in an angle of attack range which is larger than the negative angle of attack of the rotor relative to the wing chord.

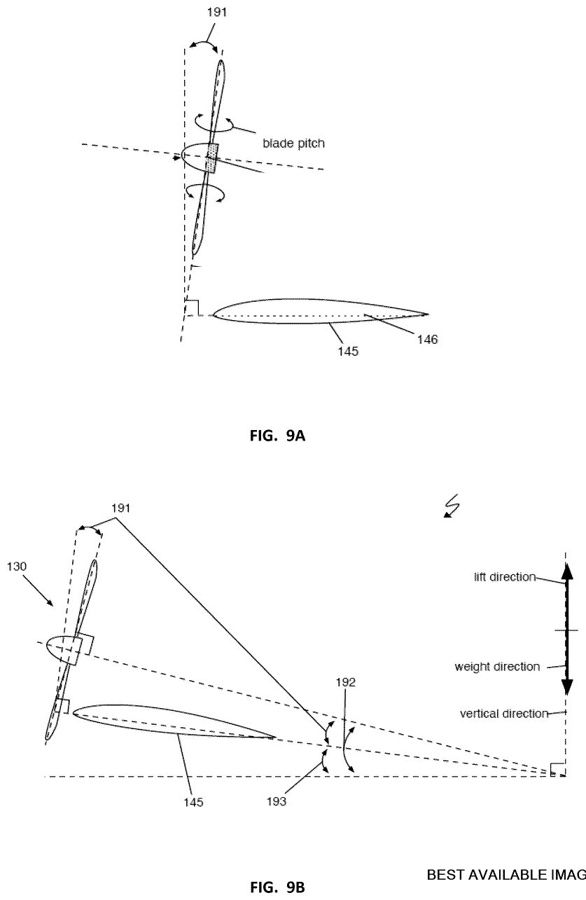

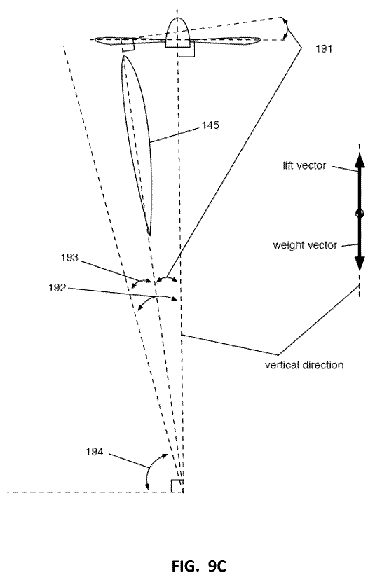

The rotors can provide lift associated with an angle of attack of the rotor disc relative to: the incoming airstream during forward flight, longitudinal axis of the aircraft, wing of the aircraft (e.g., the chord line 146 of the wing cross section 145), and/or other reference axis or plane. The angle of attack of the rotor disc relative to the wing (e.g., chord line 146 of the wing) can be negative, positive, or zero, and may be within the ranges bounded by the aforementioned values. An example of the angle of attack of the rotor disc relative to the wing 191 is illustrated in FIG. 9A. An example of the angle of attack of the rotor disc 192 is illustrated in FIG. 9B. The overall angle of attack of the rotor disc 192 is seen to be the sum of the wing angle of attack 193 and the angle of attack of the rotor disc relative to the wing 191. The rotor disc angle of attack (relative to the wing or otherwise) can be defined (e.g., measured) relative to the rotor axis of rotation, motor axis of rotation, a vector orthogonal to the rotor disc plane, and/or any other suitable reference. The angle of attack of the rotor preferably transforms based on the transformation of the tilt mechanism and/or pitch of the aircraft. Preferably, the rotor disc planes are substantially parallel to the lateral/longitudinal plane (pitch/roll plane) in the hover configuration, and angled relative to the vertical/lateral plane (yaw/pitch plane) in the forward configuration (and/or hover configuration). Accordingly, the tilt mechanism preferably transforms the wing by 90 degrees less the rotor disc angle of attack while transitioning between the forward and hover configurations (an example is illustrated in FIG. 9C), however the tilt mechanism can transform the wing by 90 degrees plus the rotor disc angle of attack while transitioning between the forward and hover configurations, exactly 90 degrees between the forward and hover configurations, and/or any other suitable transformation angle. In a specific variant, the transformation between forward and hover can include tilting past vertical (e.g., creating a rearward thrust vector) in order to arrest forward motion of the vehicle. In some aspects, as when the inboard rotors are canted to a different angle relative to the wing chord than the outboard rotors, the tilt mechanism can transform the wing by an amount controlled to provide the desired lift, attitude, and yaw rate, if any. In some aspects, the aircraft will not have any further controllable control surfaces, such as ailerons, rudders, or rear controllable horizontal stabilizers.

FIG. 1 illustrates a horizontal flight configuration for the aerial vehicle 100. The disc planes of the rotors are in a substantially perpendicular orientation relative to the horizontal flight line of the aerial vehicle.

Along the rearward sides of the main body fuselage 105 are a left side stabilizer 132a and a right side stabilizer 132b. A left side rear hatch door 130a and a right side rear hatch door 130b reside at the rear of the fuselage. A lower hatch door 131 opens downward down or to the ground. With the three hatch doors open, cargo may be able to be loaded into the payload area. In some aspects, the aircraft will not have any further controllable control surfaces, such as ailerons, rudders, or rear controllable horizontal stabilizers.

In some aspects, the main fuselage 105 may have landing struts, which may include wheels, configured to support the aerial vehicle while on the ground. A front strut 150 resides near the front of the main body fuselage 105, and somewhat rearward reside the left rear strut 151a and the right rear strut 151b.

FIGS. 2-4 illustrate the aerial vehicle 100 in a hover configuration, with the wings 101, 102 having pivoted from a horizontal forward facing forward flight configuration to a vertical facing vertical take-off and landing hover configuration. A left side pivot 101a facilitates the pivoting of the left wing relative to the fuselage 105, and a right side pivot 101b facilitates the pivoting of the right wing relative to the fuselage 105. FIG. 5 illustrates the aircraft 100 on the ground, with the landing struts 151a, 151b, 150 on the ground and the hatch doors 130a, 130b open, and the lower hatch door 131 open and residing on the ground.

FIGS. 6-8 illustrate the interior configuration of the hydrogen powered aerial vehicle according to some embodiments of the present invention. FIG. 6 illustrates a six rotor aerial vehicle 100 with dual cryogenic liquid hydrogen tanks in a forward flight configuration according to some embodiments of the present invention. In a forward portion of the main body fuselage 105 is a forward hydrogen tank 140a. In a rearward portion of the main body fuselage 105 is a rear hydrogen tank 140b. A plurality of batteries 142 reside within the main body fuselage 105. One or more fuel cells 143 reside within the main body fuselage 105. In an exemplary embodiment, there are two fuel cells 143.

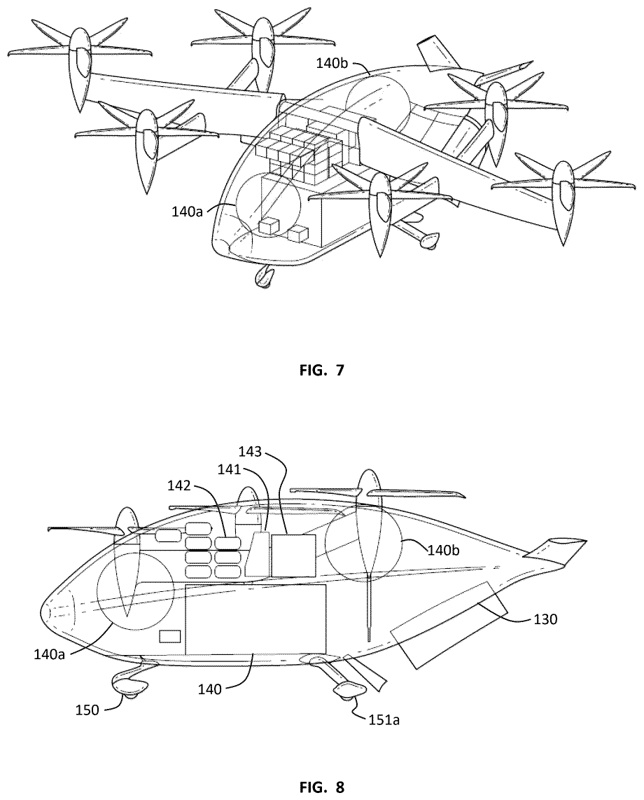

FIGS. 7 and 8 illustrate a six rotor aerial vehicle 100 in a hover configuration. As seen most clearly in FIG. 8, a stay-out area 140 for payload is within the main body fuselage 105. The stay-out area, which may be reserved for cargo, is located such that when the aerial vehicle is loaded the fuselage center of gravity remains longitudinally close to the wing's rotation center. The aerial vehicle includes a front strut 150 near the front of the main body fuselage 105, and somewhat rearward are the left rear strut 151a and the right rear strut 151b. Aerial vehicle electronics and avionics 141 may reside above the stay-out area 140. As can be seen in the representative embodiment 100, there is no pilot station, and the aerial vehicle is configures to operate in an autonomous or semi-autonomous mode.

In some aspects, the rear hydrogen tank 140b is located in an elevated position within the main body fuselage 105 to allow for cargo insertion and removal through the hatch doors. A left side rear hatch door 130a and a right side rear hatch door 130b reside at the rear of the fuselage and are configured to cover the rear hatch 130. A lower hatch door 131 opens downward down or to the ground. With the three hatch doors open, cargo may be able to be loaded into the payload area.

In some aspects, the hydrogen powered system may be configured in a redundant configuration, with the forward hydrogen fuel tank 140a coupled to a first fuel cell 143, and the rearward hydrogen fuel tank 140b coupled to a second fuel cell 143, with the system adapted to withstand a failure with one of the hydrogen power systems and still maintain operation capability to complete the flight and return the aerial vehicle.

In some aspects, the aerial vehicle may have a forward hydrogen fuel tank and a fuel cell in the very forward of the main body fuselage, with the front of the fuselage adapted to pivot open in order to receive or discharge cargo. The electrical power generated by the fuel cell in the forward portion of the main body fuselage may traverse the opening front hatch with a flexible power cable system.

Embodiments of the system and/or method can include every combination and permutation of the various system components and the various method processes, wherein one or more instances of the method and/or processes described herein can be performed asynchronously (e.g., sequentially), concurrently (e.g., in parallel), or in any other suitable order by and/or using one or more instances of the systems, elements, and/or entities described herein.

As a person skilled in the art will recognize from the previous detailed description and from the figures and claims, modifications and changes can be made to the preferred embodiments of the invention without departing from the scope of this invention defined in the following claims.

What is claimed is:

1. A vertical take-off and landing aircraft, said aircraft comprising:
a main body fuselage;
a left wing rotatably coupled to said main body fuselage;
a right wing rotatably coupled to said main body fuselage;
a plurality of left side propulsion assemblies coupled to said left wing, wherein said plurality of left side propulsion assemblies comprise:
a left side outboard propulsion assembly;
a left side inner upper propulsion assembly;
a left side inner lower propulsion assembly, wherein said left side inner upper propulsion assembly is coupled to a top end of a left side vertical pylon coupled to said left wing, and wherein said left side inner lower propulsion assembly is coupled to a bottom end of said left side vertical pylon, and wherein said left side vertical pylon is coupled to said left wing;
a plurality of propulsion assemblies coupled to said right wing, wherein said plurality of right side propulsion assemblies comprise:
a right side outboard propulsion assembly;
a right side inner upper propulsion assembly;
a right side inner lower propulsion assembly, wherein said right side inner upper propulsion assembly is coupled to a top end of a right side vertical pylon coupled to said right wing, and wherein said right side inner lower propulsion assembly is coupled to a bottom end of said right side vertical pylon, and wherein said right side vertical pylon is coupled to said right wing;
a first hydrogen fuel tank in a forward portion of said main body fuselage;
a second hydrogen fuel tank in a rearward portion of said main body fuselage; and
one or more fuel cells residing in said main body fuselage.

2. The aircraft of claim 1 wherein said left side vertical pylon cants forward above said left wing, and wherein said right side vertical pylon cants forward above said right wing.

3. The aircraft of claim 1 wherein said propulsion assemblies comprise an electric motor and a propeller, each of said propellers defining a rotor disc.

4. The aircraft of claim 2 wherein said propulsion assemblies comprise an electric motor and a propeller, each of said propellers defining a rotor disc.

5. The aircraft of claim 3 wherein the rotor disc of said left side inner upper propulsion assembly is forward of the rotor disc of said left side inner lower propulsion assembly and said right side inner upper propulsion assembly is forward of the leading edge of said right side inner lower propulsion assembly.

6. The aircraft of claim 4 wherein the rotor disc of said left side inner upper propulsion assembly is forward of the rotor disc of said left side inner lower propulsion assembly and said right side inner upper propulsion assembly is forward of the leading edge of said right side inner lower propulsion assembly.

7. The aircraft of claim 1 wherein said left wing and said right wing fixedly coupled together through the main body fuselage.

8. The aircraft of claim 5 wherein said left wing and said right wing fixedly coupled together through the main body fuselage.

9. The aircraft of claim 6 wherein said left wing and said right wing fixedly coupled together through the main body fuselage.

10. The aircraft of claim 3 wherein the rotor discs of said left side inner upper propulsion assembly and said right side inner upper propulsion assembly is forward of the leading edge of the left side wing and the right side wing, respectively.

11. The aircraft of claim 4 wherein the rotor discs of said left side inner upper propulsion assembly and said right side inner upper propulsion assembly is forward of the leading edge of the left side wing and the right side wing, respectively.

12. The aircraft of claim 5 wherein the propellers of said left side inner upper, left side inner lower, right side inner upper, and right side upper propulsion assemblies are in line with or offset from the wings at a first angle, and wherein the propellers of said left side outer and right side outer propulsion assemblies are offset from the wings at a different, second, angle, as defined by the chord of the cross-section of the wings.

13. The aircraft of claim 6 wherein the propellers of said left side inner upper, left side inner lower, right side inner upper, and right side upper propulsion assemblies are in line with or offset from the wings at a first angle, and wherein the propellers of said left side outer and right side outer propulsion assemblies are offset from the wings at a different, second, angle, as defined by the chord of the cross-section of the wings.

14. The aircraft of claim 1 wherein said second hydrogen tank resides higher than said first hydrogen tank.

15. The aircraft of claim 6 wherein said second hydrogen tank resides higher than said first hydrogen tank.

16. The aircraft of claim 13 wherein said second hydrogen tank resides higher than said first hydrogen tank.

17. The aircraft of claim 14 further comprising a rear hatch.

18. The aircraft of claim 15 further comprising a rear hatch.

19. The aircraft of claim 16 further comprising a rear hatch.
